(19) United States
(12) Patent Application Publication
(10) Pub. No.: US 2020/0165488 A1
(43) Pub. Date: May 28, 2020

(54) PROCESS FOR PRODUCING GELATIN FROM FISH SKIN BY OPTIMISATION OF THE EXTRACTION CONDITIONS

(71) Applicant: Instituto Tecnologico de la Produccion, Lima (PE)

(72) Inventors: Silvia Elvira Pandia Estrada, Lima (PE); Renzo Aaron Romero Santivanez, Lima (PE)

(73) Assignee: Instituto Tecnologico de la Produccion, Lima (PE)

(21) Appl. No.: 16/612,916

(22) PCT Filed: Jul. 26, 2018
(86) PCT No.: PCT/PE2018/000015

§ 371 Date: Nov. 12, 2019

(30) Foreign Application Priority Data
Jul. 26, 2017 (PE) 001274-2017/DIN

(51) Int. Cl. C09H 3/00; A23J 1/04; A23J 1/10

(52) U.S. Cl. CPC C09H 3/00; A23J 1/10; A23J 1/04

(57) ABSTRACT

A process for obtaining fish gelatin characterized because it comprises: (a) cleaning of fish skins; (b) washing of skins with water; (c) treating with diluted alkali solution with constant agitation; (d) washing of skins with water until the wash water is in a pH range between 6.8 and 7.2; (e) treating with diluted organic acid solution with constant agitation; (f) washing of skins with water until the wash water is in a pH range between 6.8 and 7.2 and subsequent runoff; (g) extracting gelatin by mixing the skins in an organic acid solution with a concentration of 0.2 to 0.3 weight percent by volume at a temperature of 55 to 65° C. and for 260 to 340 minutes; (h) filtering to remove skin debris and impurities; (i) drying; and (j) grinding.

### FIELD OF THE INVENTION

Commercial gelatins are commonly made from skins and bones of porcine and bovine source animals. During the last few years there has been an increase in the interest for gelatins made from marine resource skins, however, these gelatins have low gel strength values (the most important physical property of gelatins which defines their commercial value) and performance, compared to bovine and porcine gelatins. The present invention is related to a process for obtaining gelatin from fish skin that is used in food, cosmetic, pharmaceutical and photographic industries.

### BACKGROUND OF THE INVENTION

Gelatin is a soluble protein obtained by partial hydrolysis of collagen present in animal skins and bones. Source, animal age and type of collagen are intrinsic factors that influence gelatin properties. Likewise, the performance and properties of the product are influenced by the conditioning of the raw material prior to extraction (concentration of acid or alkali, time and temperature used) and the extraction conditions (time, temperature and pH).

The industry obtains gelatin mainly from the skin and bones of land mammals, particularly porcine and bovine, called traditional gelatins, which have gel strength values of 280 to 300 g (Cho et al, 2015 and Karim and Bhat, 2009). However, there are population groups that can't consume these gelatins, limiting their consumption to halal and kosher products due to socio-cultural and health-related concerns, due to cases of incidence of Bovine Spongiform Encephalopathy (BSE) (Karim and Bhat, 2009). For this reason, in recent years various methods have been developed to obtain gelatin from fish skin as it is a source rich in collagenic protein.

Gelatins of marine origins have a high positive impact in economic, social and environmental aspects, since they are obtained mainly from residues: skins, bones, or cartilage. However, the disadvantage of these gelatins is the low gel strength and yield values, as reported by Montero and Gónzales-Guillén (2000), thus restricting themselves to a lower field of application.

The document U.S. Pat. No. 5,093,474 (A) discloses the production of gelatin from fish skins, which comprises the following steps: cleaning skins to remove substantially all of the superfluous material, treating with diluted aqueous alkali, washing with water until the wash water is substantially neutral, treating with diluted aqueous mineral acid, washing with water until the wash water is substantially neutral, treating dilute aqueous citric acid and/or other suitable organic acid, washing with water until the wash water is substantially neutral, and removing gelatin by subjecting skins with water to elevated temperatures not exceeding approximately 55° C. However, this process maintains the disadvantages mentioned above by Montero and Gomez-Guillén (2000), since the gelatin obtained showed lower values of gel strength (263 g) and yield (15.0%).

### DESCRIPTION OF THE INVENTION

As a solution to the problems of obtaining gelatins of marine origin with lower values of gel strength and yields than traditional gelatins, a new process was developed to obtain a powdered fish skin gelatin with high values of gel strength and yield, by means of an optimization technique, evaluating the influence of three variables that affect the extraction process (temperature, time and concentration of citric acid) on two response variables (gel strength and protein yield of citric acid). As a result of this optimization, the gelatin obtained presented a high viscosity value.

In order to achieve these results, the following three variations were made with respect to the procedure established in publication U.S. Pat. No. 5,093,474 (A):
A single wash with citric acid, different to the previous antecedent which does it with 2 values (first with mineral acid and second with citric acid). Performing this procedure in the invention, a gelatin with better properties is obtained, which is reflected in its gel strength value.
Extraction of gelatin in acidic medium, in citric acid solution (food grade) in a percentage of 0.25±0.05% (p/v), in contrast to the antecedent which makes extraction using only water. The concentration of citric acid used during extraction allowed to obtain higher yields of gelatin. On the other hand, the acid concentration directly influenced the final pH of the gelatin, which resulted in an increase in the gel strength.
Alkali and acid treatments and washes were carried out at low temperature (10 to 12° C.), unlike the antecedent that carried out the treatments and washes at an ambient temperature (15 to 27° C.). Making this procedure in the invention, gelatins with higher yields are obtained.

It presents a first improvement in the non-deterioration of the raw material, which has a direct impact on the quality of the same as it obtains a gelatin with better properties, maximum gel strength values (greater than 385 g); and a second improvement in the extraction process as it obtains higher yields (greater than 20.0%).

Due to these variations, the fish skin gelatin obtained has a wider range of applications in the food, pharmaceutical and cosmetic industries, due to its quality and its other physical properties of viscosity, melting temperature and gelling temperature. The gelatin obtained under the process of the present invention presented a viscosity of 11.0 cP, while the gelatin obtained under the procedure established in the publication U.S. Pat. No. 5,093,474 (A) presented a value of 5.1 cP.

The gelatin obtained can be used as an ingredient in manufacture of foodstuffs such as pastry products due to its good melting temperature (25.6° C.) and gelling characteristics (17.6° C.), in meat products such as hams or sausages for their ability to improve texture and structure, in edible coatings due to their good film-forming capacity or in pharmaceutical applications for the manufacture of hard or soft capsules.

Fish skin gelatin powder meets the standards of an edible gelatin according to NTP 209.086 because its protein content is 88.3%, the moisture content and ash content are less than 16.0% and 3.0% respectively and has a pH value between 4.0 and 7.5.

It also complies with the standards dictated by GMIA (Gelatin Manufacturers Institute of America), since its ash content is less than 2.0% (maximum recommended limit) and has a pH value between 3.8 and 7.5 for edible gelatins.

The general process comprises the following steps:
1. It begins with the collection of fish skins, the skins are cleaned by separating the remains of muscle, scales and other impurities from the skins,
2. Washing the skins with cold water (10 to 12° C.),
3. The skins are treated with a cold solution (10 to 12° C.) of sodium hydroxide (NaOH) in a percentage between 0.2% and 2.0% (w/v) for a time between 6 and 8 hours with constant agitation.
4. The skins are washed with cold water (10 to 12° C.) until the wash water is in a pH range between 6.8 and 7.2.
5. The skins are treated with a cold solution (10 to 12° C.) of citric acid (food grade) in a percentage between 0.4% and 1.0% (w/v) for a time between 1 and 2 hours and with constant agitation.
6. The skins are washed again with cold water (10 to 12° C.) until the wash water is in a pH range between 6.8 and 7.2 and then the skins are drained.
7. Extraction of the gelatin at an acid pH by mixing the skins in citric acid solution (food grade) in a percentage of 0.25±0.05% (w/v) at a temperature of 60.0±5.0° C., for a time of 300±40 minutes, using a fish skin ratio: citric acid solution equal to 1:3 (w/v) and maintaining constant agitation.
8. Filtering to remove skin debris and impurities.
9. Drying by hot air at temperatures below 60° C. for the time needed to obtain the dry gelatin sheets.
10. The grinding is carried out to obtain the final powdered product.

### DESCRIPTION OF THE FIGURES

FIG. 1: it shows the contours for the gel strength, as a function of the temperature and concentration variables of citric acid, it is observed the intercalation between the temperature and concentration variables of citric acid on the gel strength of the gelatins obtained. In the same, it can be seen that when the extraction of gelatin is carried out at low temperatures (approximately between 40.0 and 55.0° C.) and using low concentrations of citric acid (approximately between 0.1 and 0.5%) gelatins are obtained with the highest values of gel strength (>400 g); however, these values decrease considerably (from 370 to 280 g) when the temperature is increased from 62.5° C., independent of the concentration of citric acid.

FIG. 2: it shows the contours for protein extraction yield, as a function of temperature and citric acid concentration variables. It is observed the interaction between the temperature and concentration of citric acid variables on the extraction yield in obtaining the gelatins. Here, gelatins with higher yields are obtained with extraction at high temperatures (>55.0° C.) and using low concentrations of citric acid (approximately between 0.20 and 0.55%).

FIG. 3: it shows the flow diagram of the gelatin making process.

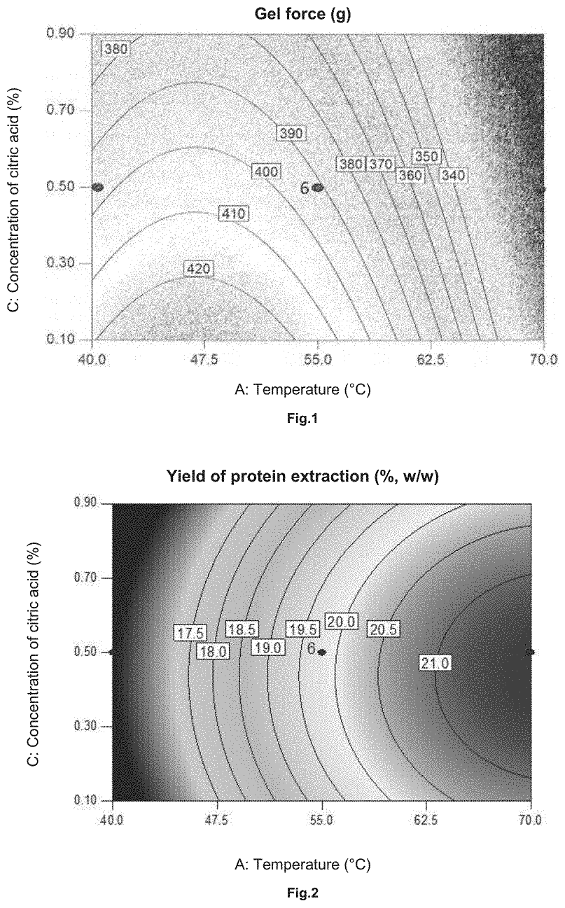

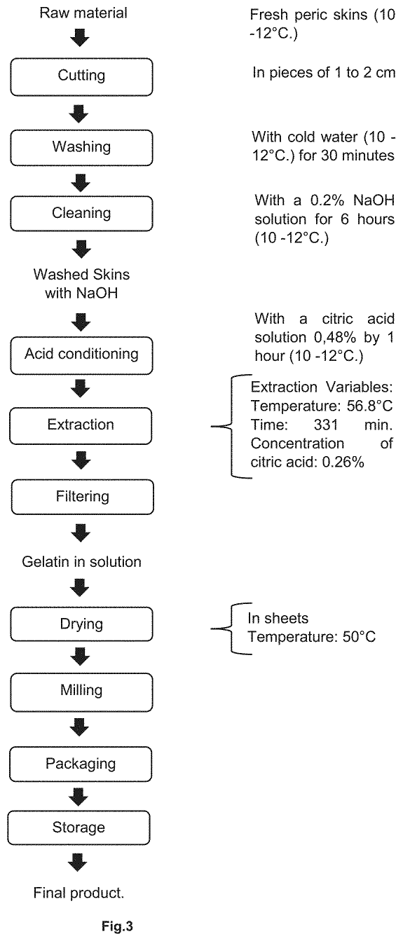

### PREFERRED EMBODIMENT OF THE INVENTION

A Central Composite Design was used for the optimization. Table 1 shows the study variables and the values used for each variable in the design.

TABLE 1
Variables and their respective values used for the
step corresponding to the central composite design.

| Variable | Values used for the variables | | | | |
|---|---|---|---|---|---|
| Temperature (° C.) | 40 | 46.1 | 55 | 63.9 | 70 |
| Time (minutes) | 60 | 129 | 230 | 331 | 400 |
| Concentration of | 0.1 | 0.26 | 0.5 | 0.74 | 0.9 |
| citric acid % (w/v) | | | | | |

Table 2 shows 20 treatments defined by the design and different combinations of the temperature, time and concentration of citric acid variables used, as well as the results obtained from gel strength and protein extraction yield in each of the treatments.

TABLE 2
Gel strength and protein extraction yield in the
treatments made in the central composite design.

| | | | | Response Variables | |
|---|---|---|---|---|---|
| | Study variables | | | | Yield of |
| | Temper- | | Concentration | Gel | protein |
| | ature | Time | of citric acid | strength | extraction |
| Treatment | (° C) | (minutes) | (%) | (g) | (%) |
| 1 | 46.1 | 129 | 0.26 | 454.2 | 16.84 |
| 2 | 63.9 | 129 | 0.26 | 350 | 20.41 |
| 3 | 46.1 | 331 | 0.26 | 396.9 | 18.34 |
| 4 | 63.9 | 331 | 0.26 | 346.7 | 21.36 |
| 5 | 46.1 | 129 | 0.74 | 404.5 | 16.71 |
| 6 | 63.9 | 129 | 0.74 | 338.0 | 20.25 |
| 7 | 46.1 | 331 | 0.74 | 381.0 | 17.49 |
| 8 | 63.9 | 331 | 0.74 | 335.3 | 20.97 |
| 9 | 40.0 | 230 | 0.50 | 390.1 | 15.74 |
| 10 | 70.0 | 60 | 0.50 | 287.3 | 21.35 |
| 11 | 55.0 | 400 | 0.50 | 409.5 | 18.89 |
| 12 | 55.0 | 230 | 0.50 | 370.8 | 20.56 |
| 13 | 55.0 | 230 | 0.10 | 423.3 | 19.12 |
| 14 | 55.0 | 230 | 0.90 | 360.9 | 18.66 |
| 15 | 55.0 | 230 | 0.50 | 388.8 | 19.92 |
| 16 | 55.0 | 230 | 0.50 | 383.3 | 19.89 |
| 17 | 55.0 | 230 | 0.50 | 394.3 | 19.76 |
| 18 | 55.0 | 230 | 0.50 | 390.5 | 19.76 |
| 19 | 55.0 | 230 | 0.50 | 396.9 | 19.80 |
| 20 | 55.0 | 230 | 0.50 | 386.0 | 19.83 |

Table 3 shows optimization solutions for obtaining gelatins with gel strength values greater than 385 g and protein extraction yield greater than 20.0%.

TABLE 3
Solutions of optimization and responses
for obtaining gelatin from fish skin.

| | | | | | Yield of |
|---|---|---|---|---|---|
| Optimi- | Temper- | | Concentration | Gel | protein |
| zation | ature | Time | of citric acid | strength | extraction |
| solutions | (° C.) | (minutes) | (%) | (g) | (%) |
| 1 | 56.8 | 331 | 0.26 | 389.1 | 20.58 |
| 2 | 56.2 | 331 | 0.27 | 390.6 | 20.48 |
| 3 | 57.1 | 331 | 0.29 | 386.4 | 20.66 |
| 4 | 56.2 | 296 | 0.26 | 394.6 | 20.26 |
| 5 | 56.7 | 265 | 0.26 | 395.6 | 20.17 |
| minimum | 56.2 | 265 | 0.26 | | |
| maximum | 57.1 | 331 | 0.29 | | |

In accordance with the above, a test was carried out on the skins of mahi-mahi or common dolphinsish (Coryphaena hippurus), according to the following process characteristics:
(1) The mahi-mahi skins are cleaned by separating the remains of muscle, flakes and other impurities from the skins.
(2) Washing the skins with cold water (10° C.).
(3) The skins are treated with a cold solution (10° C.) of 0.2% (w/v) sodium hydroxide (NaOH) for 6 hours with constant agitation.
(4) Next, the skins are then washed with cold water (10° C.) until the wash water is in a pH range between 6.8 and 7.2.
(5) The skins are treated with a cold solution (10° C.) of citric acid (food grade) 0.48 (w/v) for 1 hour with constant agitation.
(6) The skins are washed again with cold water (10° C.) until the wash water is in a pH range between 6.8 and 7.2 and then the skins are drained.
(7) Gelatin extraction at acid pH is done by mixing the skins in a 0.26% (w/v) citric acid solution (food grade) at a temperature of 56.8° C. and a time of 331 minutes, using a mahi-mahi skin ratio: citric acid solution equal to 1:3 (w/v) and maintaining constant agitation.
(8) Filtering to remove skin debris and impurities.
(9) Drying in hot air by forced convection at a temperature of 50° C.
(10) Finally, a grinding process is carried out to obtain the final powdered product.

The gelatin obtained from this example showed a gel strength of 386.6 g; a protein extraction yield of 20.4%; a viscosity of 11.0 cP; a protein percentage of 88.3%; and a pH of 4.9.

For reasonable generalization, the ranges to be protected in the attached claims are the concentration of citric acid (food grade) from 0.20 to 0.30% (w/v), the time from 260 to 340 minutes and the temperature from 55.0 to 65.0° C. for the extraction step.

What is claimed is:

1. A process for obtaining gelatin from fish skins of genus Coryphaena characterized in that the process comprises the following steps:
(a) cleaning the fish skins;
(b) washing the fish skins with water at a temperature of 10 to 12° C.;
(c) treating the fish skins with a solution of a diluted alkali, at a temperature of 10 to 12° C., with constant agitation;
(d) washing the fish skins with water at a temperature of 10 to 12° C., until the washing water is in a pH range between 6.8 and 7.2;
(e) treating the fish skins with a citric acid solution in a percentage between 0.4% and 1.0% weight per volume, at a temperature of 10 to 12° C., and with constant agitation;
(f) washing the fish skins with water at a temperature of 10 to 12° C., until wash water is in a pH range between 6.8 and 7.2, and then the wash water is drained;
(g) extracting gelatin at an acid pH by mixing the fish skins in citric acid solution in a percentage from 0.2% to 0.3% weight per volume, at a temperature between 55 and 65° C., and for a time between 260 and 340 minutes;
(h) filtering the gelatin of step (g) to remove skin debris and impurities;
(i) drying the gelatin of step (h); and,
(j) grinding the gelatin of step (i).

2. The process according to claim 1, characterized in that, in step (g), a ratio between the fish skins and the citric acid solution equal to 1:3 weight by volume is used, and with constant agitation.

3. (canceled)

4. The process according to claim 1, characterized in that, the step (c) is performed for a time between 6 and 8 hours.

5. The process according to claim 1, characterized in that, in step (e), the diluted alkali is sodium hydroxide in a percentage between 0.2 and 2.0% weight per volume.

6. (canceled)

7. The process according to claim 1, characterized in that, the step (e) is performed for a time between 1 and 2 hours.

8. (canceled)

9. The process according to claim 1, characterized in that, in step (i), the drying is carried out at temperatures below 60° C.
